(19) United States
(12) Patent Application Publication
(10) Pub. No.: US 2009/0211936 A1
(43) Pub. Date: Aug. 27, 2009

(54) Method and device for serving skewered food

(76) Inventor: W.G. Don Korff, (US)

Correspondence Address: W.G. (Don) Korff, 11069 Clear Meadows Drive, Las Vegas, NV, 89134, US

(21) Appl. No.: 12/072,095

(22) Filed: Feb. 25, 2008

(51) Int. Cl. A47J 43/18; A47J 37/04

(52) U.S. Cl. 206/459.5; 99/421 R

(57) ABSTRACT

A device is disclosed for suspending one or more loaded kabob skewers in a vertical position above a dining plate or similar utensil, thus providing a method for directly serving food prepared on a skewer without first separately having to remove it from that skewer.

In one exemplar embodiment, a support column is disclosed for hanging the loaded skewer high above the plate, so that food is easily pushed downward and away from it with one hand, forcing it to fall directly on to the plate poised below it, without the need to hold the skewer securely in the other hand.

In other embodiments the skewers are not only suspended in the vertical position, but are gripped by a clamping mechanism, holding them rigid and steady, which aids substantially in the removal effort. The device provides a distinctly new and attractive look to any dining table, and further visual delight is easily added by utilizing decorative ornamental elements in its construction with virtually limitless possibilities of artistic expression. The application of its primary useful features, in combination with its visually appealing attributes makes this invention not only a desirable utensil to have in the house for family and guests, but for all the same reasons it brings charm, efficiency and uniqueness to restaurants, clubs and related establishments known to serve this type of cuisine to the public.

### BACKGROUND

1. Field of Invention

This invention relates to a method and apparatus for serving food that has been grilled or otherwise prepared on a skewer, such as chunks of meat, seafood, vegetables and/or fruit, this food being known as shish kabob, or kabob, kebab, brochette, satay, souvlaki, shashlik, yakitori and perhaps other names, depending on the national origin of the cuisine. For the sake of clarity and brevity, such food and the process of preparing and serving it will hereinafter be referred to as “kabob” only.

2. History and Prior Art

The most common form of preparing kabob is to impale chunks of food on sticks (skewers) having a pointed end for piercing, and either an eyelet, hook, handle or just plain portion on the opposite end for use as a handhold. Once the skewers are loaded with assorted combinations of meats, vegetables, fruits etc. they are placed on a grill or otherwise suspended over an open fire or other heat source, requiring periodic rotating to assure adequate grilling on both sides of the food.

Other types, such as fruit or certain vegetable kabobs may just be served uncooked, yet presented on a skewer as a garnish or decorative addition to the menu.

Since the art of preparing kabob dates back many centuries, the earliest skewers were made of wood, and for reasons of tradition as well as low cost, wooden skewers are still in use today. However the most common skewers in use nowadays are made of steel or other sturdy metals, and they are available in various lengths and cross sections. Whereas the earlier skewers had a round cross section, most present day skewers are either square or rectangular, because this prevents the skewer from turning within the food chunks. A round profile often makes it difficult, if not impossible to turn the kabob over for cooking on both sides. Some types of skewers are even made with double prongs, allowing each chunk of food to be impaled on both prongs. This prevents even the most tender food chunks, such as fish and soft fruits from rotating on the skewer.

While the shape and style of skewers, or the actual preparation of any kind of kabob, are in themselves not germane to my invention, it is the way kabob meals are customarily served that has been improved by my invention.

Once the grilling is done, there are essentially only three ways to serve kabob, no matter what the type of food, the method of preparation, or the type and shape of skewers used.

One method is to remove the finished food chunks from all the skewers that are being deployed, and collect them either altogether, or sorted by their type, (i.e. meat, vegetable etc) on a common plate, bowl or other container, to which all participants then have access to serve themselves.

Another method is to place all the “done” skewers on a common plate or board, without removing any of the food from them. Each participant then selects one or more of the loaded skewers and proceeds to remove the food from them on to his or her individual plate.

The third method is to place the “done” skewers directly on to each participant's individual plate, which helps to assure proper distribution of pre-specified choices made by the participants prior to grilling, such as type of meat, cooked rare, medium, well done, etc.

With either and all of the above methods, it is necessary to slide the food chunks off of the skewer, either individually or several at a time, by inserting a fork or similar instrument behind them and exerting force to push them off at the tip. To do this, the loaded skewer is firmly held in one hand, while the pushing force is being applied with the other.

While many may have become skilled in this process, there are those who find it difficult to hold a loaded skewer securely with one hand, considering that it must be held at the extreme end opposite from the tip, and held with sufficient strength, in order to withstand the force required to slide off food chunks that have become even slightly bonded to the skewer during cooking, especially if they are located further away from the tip.

Consequently, where a person may lack the skill or the strength to apply such forces, there are frequent mishaps, such as the disengaging food missing or even overshooting the intended target area, or loaded skewers being dropped unintentionally. The potential for such mishaps is minimized the more the loaded skewer can be held in a near vertical position during this procedure, thus forcing the released kabob to fall directly downward onto the plate. However, due to the length of the skewer this is difficult to do, especially from a seated position. It requires considerable strength and agility to hold up a fully loaded skewer with one hand, in a vertical position, high enough above a plate placed on a table, and hold it secure enough and long enough to force multiple pieces of kabob to be released from it with the other hand. Thus there is a tendency to hold the skewer in a more horizontal position, which then increases the likelihood of overshooting the point onto which the kabob is intended to fall. These difficulties are exacerbated where the skewers are made of metal, with a non-insulated handle end, requiring the use of gloves or tongs upon removing them from the heat source to avoid getting your fingers burned holding the hot skewers. While it is normal and proper for the grill cook to wear gloves or even thick mittens to avoid burns, this is not a desirable requisite for the diners.

Primary Object

Accordingly, it is an object of this invention to provide a method and apparatus for serving food prepared on a skewer, which completely eliminates the need to hold a skewer loaded with food in one hand in order to remove the food with the other. My invention not only enables persons with limited physical strength, including the elderly and small children, to handle this task with ease and complete safety, but it does so without requiring the user to possess any kind of skill or physical dexterity. In this way, my invention constitutes a fourth, and thus a distinctly different, novel and unique way to serve kabob.

The apparatus consists of a supporting element or “serving column” rising from behind the dining plate to a height sufficient to vertically suspend one or more of the loaded skewers directly above the plate, including mechanisms to quickly secure the skewer(s), so that the user can easily slide the food off one piece at a time, directly onto the plate poised closely beneath it, without obscuring or hindering normal access to all other areas of the plate.

Once all food has been removed, the empty skewer is easily released and returned for repeated servings.

Decorative Contribution

In addition to these practical aspects, my invention also provides uncommon visual pleasure to the dining experience by presenting kabob type cuisine in a manner not heretofore known. Not only does the sight of the loaded skewers poised above the plate provide a direct eye appeal to awaiting diners, but the visual pleasure may be further enhanced by utilizing decorative ornamental elements in the construction of the serving column itself, thereby contributing a uniquely new and delightful element of table decoration.

This combination of advantages is of benefit not only for use in the home, but is also an ideal attraction for restaurants, social dinners, picnics, parties and other public or private culinary gatherings. Business enhancing features such as business names, logos, graphic elements etc. are easily integratable with the main elements.

Other New and Novel Improvements

The design and unique functionality of this invention has furthermore led to the creation of another useful feature not previously available in the preparation of kabob type cuisine, namely the ability to clearly and positively display certain preferences on the part of all the participating diners to those in charge of the actual food preparation.

As will become apparent from the detailed descriptions following herein, this feature is novel in its simplicity and thus in it's easily understood “obvious” implementation, requiring little if any user instructions, and is achieved by providing self explanatory components.

This feature consists of providing a selection of color coded and/or imprinted labels to all participants prior to preparing the kabob, each label appropriately indicating such choices as “Rare”, “Medium”, “Well Done”, “Beef”, “Pork”, “Chicken”, “Lamb”, “Shrimp”, or whatever else may be applicable for the occasion. All guests simply select the label or labels representing their preference and affix it to their individual serving column at a most easily seen location provided for that purpose. These labels are reusable and easily interchanged for subsequent use.

The person or persons responsible for preparing the kabob can now immediately assess the quantity, choice of selection and degree of preparation required for all participants, without necessarily having to confer with each of them individually, and moreover, even if some are temporarily absent from their table. This is of particular advantage wherever one or more large groups are to be served, but even the smallest dining parties will benefit from communicating their individual's wishes in this manner.

A second group of labels is being provided to the preparers of the kabob, bearing the same color code and/or imprinted designation as is used for the ones chosen by the diners. However these labels are designed to be affixed in an interchangeable manner to the individual kabob skewers.

The benefits of this labeling combination cannot be overstated: Not only is any miscommunication between diner and food preparer practically eliminated, but the preparer is now able to label each and every guest's skewer with the exact “end result” to be aimed for, before even beginning the grilling procedure. It is almost like having the menu displayed on the cooking grill. To enhance the execution of this process even further, the labeling of each skewer may include references for “Side 1” and “Side 2”, thus aiding to avoid over- or undercooking.

And once the skewers are “done”, there is no need to remember which one belongs to whom. Simply distribute and attach them to the serving columns with matching labels in front of each diner.

Still another “unspoken” signal can be given by each diner via the way their labels are positioned on the serving column, such as “Up” position indicating “ready for more”, “Down” position “temporarily pausing”, as an example. This and other possible scenarios are described in greater detail in the paragraphs and drawings provided hereinafter.

This entire labeling feature is optional and not in itself essential to the main objective of serving kabob “on the skewer” as described above.

Multiple Designs

The novel features which are believed to be characteristic of this invention are the basic function of vertically suspending one or more loaded kabob skewers above a plate, bowl or other vessel, the construction of its elements, and the method of affixing the skewers thereto. The latter two are subject to a multitude of design possibilities, offering choices based on mounting preferences, ease of assembly and disassembly, ease of cleaning, type of material, method of production, considerations for the decorative aspect, and not least, the cost of manufacturing and shipping. Another important object of this invention is to permit the utilization of not merely one unique type and size of kabob skewer, but to accommodate the widest possible range of existing shapes, sizes and types of skewers commercially available anywhere. Thus, while there may on the one hand be a basic simplified version, there are innumerable others, all of which could thus be considered typical embodiments of this invention.

The same holds true for the design of the labels described in the previous paragraph, whether it relates to their material, shape, color, inscription or method of attachment to any of the aforementioned implements, any of which may be altered in innumerable ways by those skilled in the art.

All of this will be better understood from the following description and the accompanying drawings, in which several preferred embodiments of the invention are illustrated by way of example.

It is to be expressly understood, however, that the drawings are for the purpose of illustration and description only, and are not intended as a definition of the limits of the invention.

### BRIEF DESCRIPTION OF THE DRAWINGS

FIG. 1A is a front view showing the basic elements of the present invention.

FIG. 1B is a side view of FIG. 1A.

FIG. 1C is a top view of FIG. 1A, shown with a singular serving column.

FIG. 1D is an alternate top view of FIG. 1A, shown with a multiple of serving columns.

FIGS. 2A, 2B and 2C are isometric views of a pocket type skewer fixture, showing the progression of affixing a certain type of skewer.

FIG. 3A is an enlarged sectional view of a skewer clamping fixture, taken along the line A-A of FIG. 3E, showing details of its components.

FIG. 3B is a cross section view of three types of dual prong skewers.

FIG. 3C is a cross section view of three types of single prong skewers.

FIG. 3D is an enlarged sectional view similar to FIG. 3A, showing a dual prong skewer of rectangular cross section clamped in position.

FIG. 3F is an enlarged sectional view similar to FIGS. 3A and 3D, showing a single prong skewer of square cross section clamped in position.

FIG. 3E is a partial side view showing a dual prong skewer clamped in position.

FIG. 3G is a partial side view showing a single prong skewer clamped in position.

FIG. 4A is an enlarged isometric view of an alternate type skewer clamping fixture, showing details of its components.

FIGS. 4B, 4C and 4D are isometric views showing the progression of affixing a single prong skewer incorporating a rectangular cross section and a solid handle.

FIGS. 5A with 5B is a side view of another embodiment with height adjustment, to accommodate skewers of different lengths.

FIG. 6 is a partial side view of the base portion incorporating a protective coating.

FIGS. 7A, 7B and 7C are side views and a partial section of a stand-alone adaptation of the support column.

FIG. 8A is a side view, showing a decorative element added to the support column.

FIG. 8B is a top view of FIG. 8A, with similar decorative elements also added to the base portion.

FIG. 8B is an alternate side view, showing an example of commercial art added to a stand alone column, as would benefit a restaurant or other public venue.

FIGS. 9A. 9B, and 9C show the adaptation of column mounted receptacles for various dining accoutrements.

FIGS. 10A. 10B, and 10C show the application of a new and novel signage element applied to the support column.

FIGS. 10D. 10E, 10F, 10G and 10H show that same signage applied to a table mounted support fixture when used at dining events serving other than kabob food, where skewer serving devices such as are shown in FIG. 10B are not in use.

FIGS. 11A. and 11B show a unique skewer handle incorporating a removable sign which interplays with the sign element of FIG. 10.

FIGS. 11C and 11D are sectional views taken along line A-A of FIG. 11A,

FIG. 11E is an enlarged isometric detail of the spring seen in FIGS. 11C and 11D.

FIG. 12A is a side view of an adapter base for outdoor use, compatible for attaching a skewer support device.

FIG. 12B is a top view of FIG. 12A.

FIG. 12C is a partial section, taken along lines A-A of FIG. 12B

FIG. 13 is a isometric view of a modified skewer.

### DESCRIPTION OF BASIC ELEMENTS

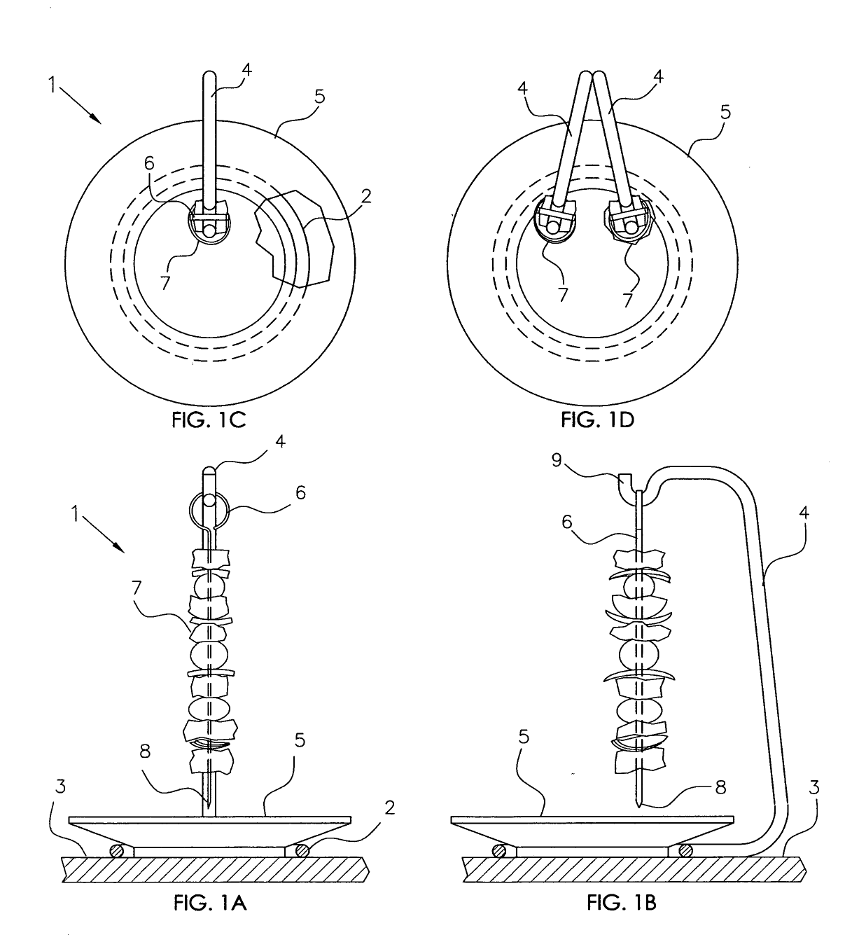

Referring now to the drawings, FIG. 1A shows the front view of a kabob serving device 1, consisting of a ring shaped base 2 resting on table surface 3, and an integral support column 4 rising from the rear portion of base 2. Base 2 is so proportioned as to permit a typical dinner plate 5 to be placed within its inner confines, resting firmly on table surface 3. While generous clearances are provided, the confines of this placement insure that plate 5 remains in an adequately concentric position relative to base 2. Consequently, once any skewer 6, loaded with kabob food 7, is placed upon the device, it will be reliably suspended above a predetermined area of dinner plate 5, with its tip 8 poised just a short distance above it. From that position it will then require little effort to dislodge the food chunks 7, one by one, precisely onto a designated area of plate 5, using one or more forks or similar utensils, while leaving the remaining portions of the plate free and unobstructed for other servings.

FIG. 1B is a side view of this embodiment, showing skewer 6 suspended from hook portion 9 at the top of support column 4.

FIG. 1C is the top view of the foregoing construction, depicting a singular support column 4, capable of holding one skewer 6. Where it is desirable to serve more than one skewer at a time, construction of the device may provide a multiple of such support columns 4, as shown in the alternate top view FIG. 1D.

Other Means of Affixing Skewers

While the device shown in FIGS. 1A and 1B offers distinct advantages over removing food from a hand held skewer, it has certain limitations which call for further improvements. One limitation is that it can only serve skewers having an open loop for a handle. A more pertinent disadvantage is that merely hanging the skewer from a hook allows excessive movement of the tip end 8, making it difficult to maintain it in a steady position while exerting downward force on the food chunk 7 nearest the tip. The solution is to provide a means for holding the skewer in a steady position, by preventing as much lateral motion of the tip portion 8 as possible. In addition, the device must be able to accommodate other types and sizes of skewers, having different shapes of handles, or even the absence of a handle. Such solutions are now described below.

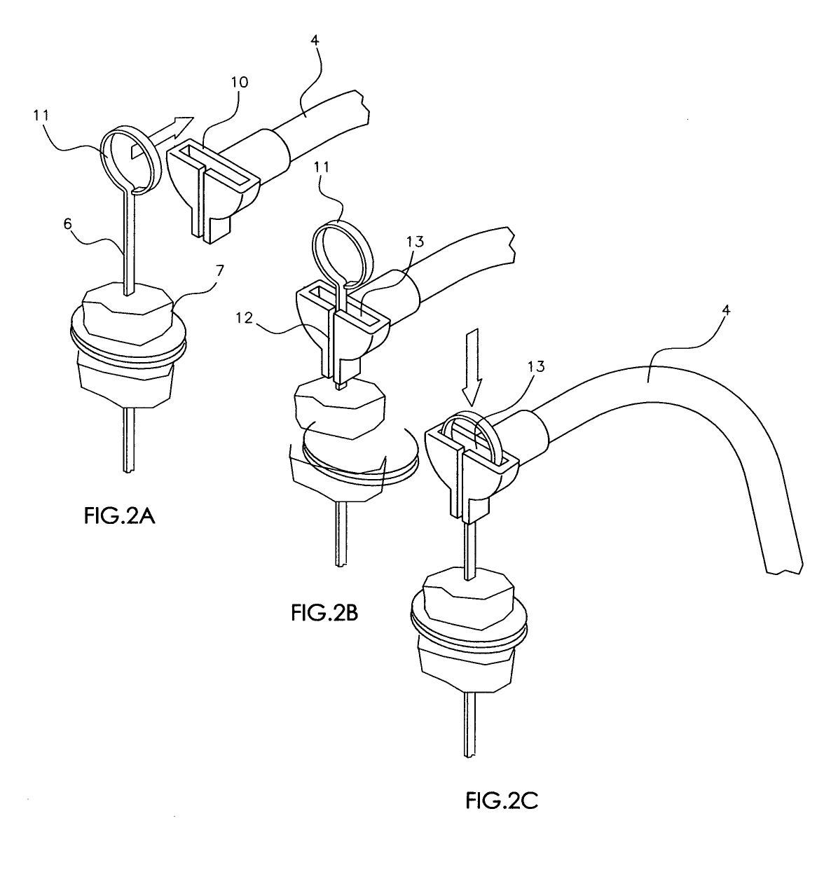

FIG. 2A depicts a retaining bracket 10, mounted to the top of support column 4, suspending a widely used type of skewer 6 that incorporates a common loop handle. The uppermost portion of loaded skewer 6 is inserted horizontally through slot 12, (FIG. 2B), then simply lowered into pocket 13, which conforms with generous clearances to the shape of the skewer handle 11. Once seated, the confines of pocket 13 restrict the encased portion of skewer handle 11, thus preventing it from tilting in any direction (FIG. 2C).

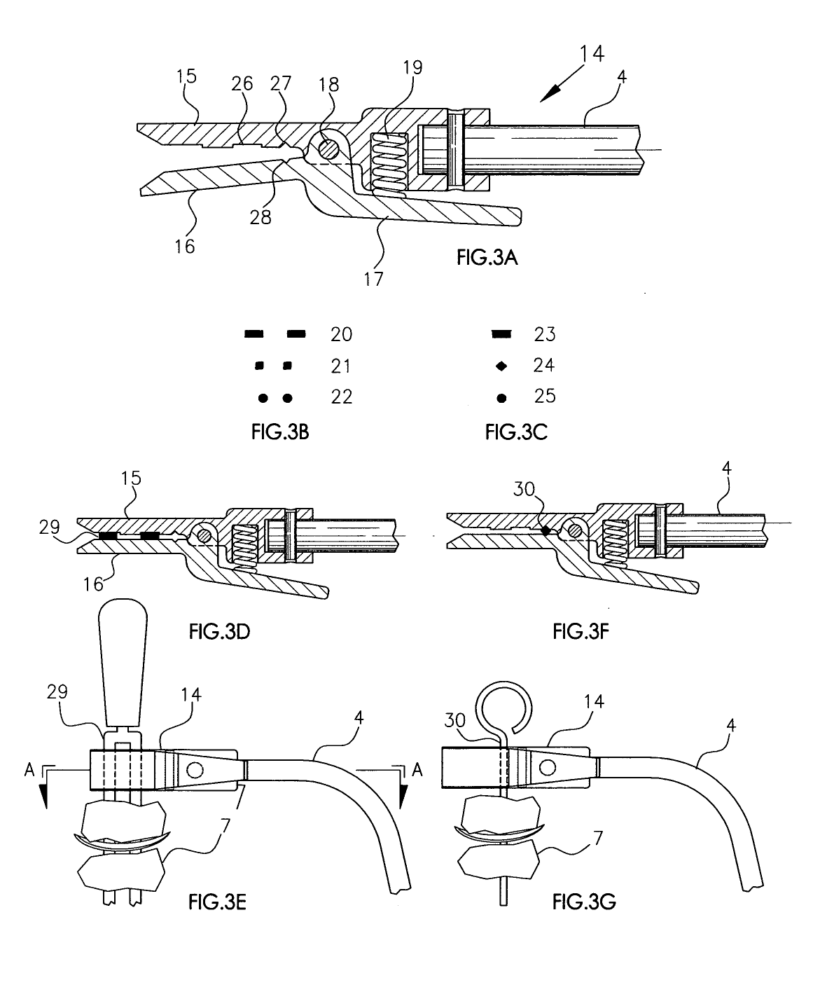

FIG. 3A shows a clamping device 14 mounted at the top of support column 4, consisting of fixed portion 15, hinged portion 16 including release handle 17, pivot pin 18, and compression spring 19. This device will securely clamp a number of different types, shapes and sizes of kabob skewers, namely:

FIG. 3B shows the profiles of dual prong skewers made of two blades 20 of rectangular section, dual prong skewers made of two blades 21 of square section, and dual prong skewers made of round sections 22.

FIG. 3C shows the profiles of single prong skewers of rectangular 23, square 24 and round 25 cross section.

Depressing handle 17 against spring force 19, the clamp jaws open to permit insertion of the uppermost portion of the desired skewer. For single skewers, it's blade must be inserted into the appropriate groove 26 or 27 on the fixed side of the clamp. Releasing the handle will apply a strong spring force on the skewer blade, pressing it tightly against the recessed groove. There is the rectangular groove 26 for rectangular prongs, the V-shaped groove 27 on the fixed jaw, and the V-shaped groove 28 on the hinged jaw, directly opposite of groove 27. This profile of opposing V's is provided to grip square shaped skewer cross sections in the diagonal direction, which permits secure accommodation of any square profiles expected to have slightly different dimensions.

By thus firmly engaging the uppermost portion of any skewer blade within correspondingly shaped grooves, the resulting clamping action becomes extremely positive, imparting a high degree of rigidity to the entire length of the skewers. Lateral movement at the tip end 8 is negligible, thus making it easy and efficient to remove food 7 from the blades.

FIG. 3E shows a typical dual pronged skewer 29 in clamped position, with FIG. 3D offering the sectional view taken along line A-A of FIG. 3E.

FIG. 3G shows the clamping device 14 holding a single prong skewer 30 of square cross section in position, being retained within the V-shaped groove 27 of fixed portion 15 and 28 of hinged portion 16, close to the pivot point 18, as clearly visible in FIG. 3F, which is the sectional view taken along line B-B of FIG. 3G. Skewers having a round cross section 25 are also intended to be clamped within the opposing V-grooves 27 and 28, and as is the case with square profiles 24, the round profiles 25 may likewise have varying diameters without impeding the gripping contact of the clamping surfaces. This capability makes it possible to include even old fashioned wooden skewers among those able to be served by this device.

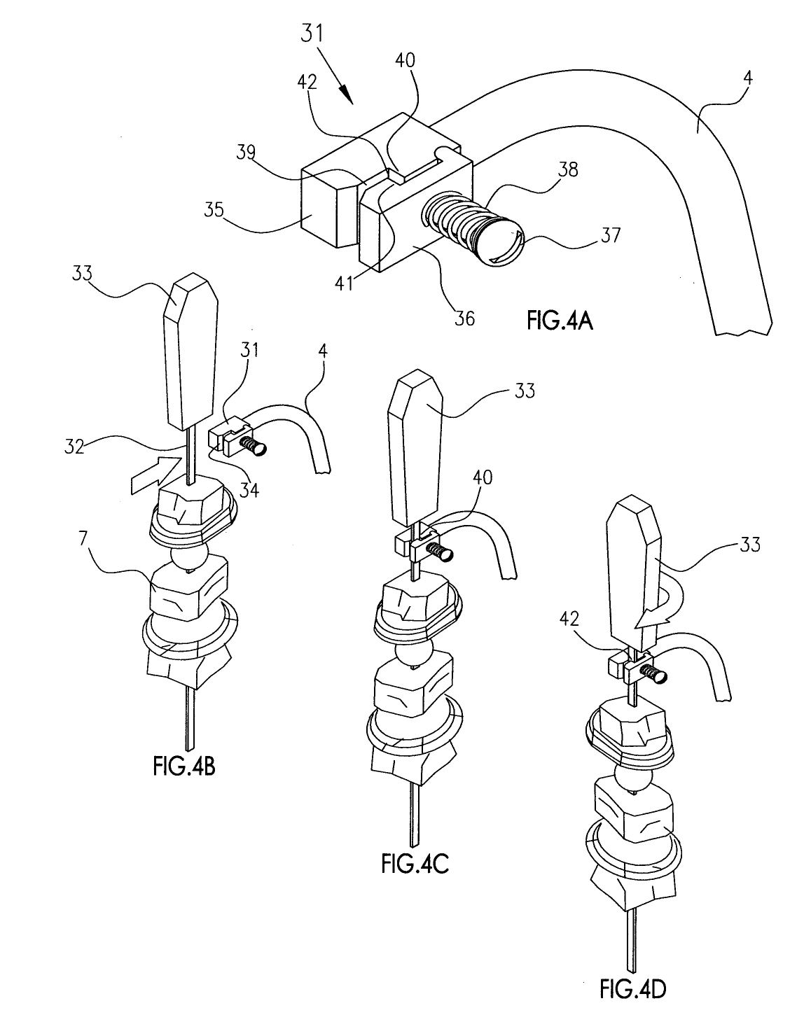

FIG. 4A, shows still another form of clamping fixture 31, mounted atop support column 4. This version is used for a popular type of skewers having a rectangular cross section 32 and various forms of solid handles 33. In addition to providing superior rigidity to the skewer in the clamped position, it requires the use of only one hand to place the skewer into position and lock it in place with a ¼ turn twist motion.

FIG. 4B shows the loaded skewer ready to be inserted into slot 34 of clamping fixture 31, which can be seen more clearly in the enlarged detail of FIG. 4A. It consists of a fixed portion 35 attached firmly to the end of support column 4, and the clamping plate 36, held in engagement with portion 35 by bolt 37 in concert with compression spring 38. The entry sides of parts 35 and 36 are contoured to form an aperture 39 when vacant, allowing the narrow edge of the rectangular skewer blade 32 to be inserted into the slot thus formed, until it contacts the distal edge 40. FIG. 4C shows the skewer in that position. As soon as skewer 32 starts to be manually rotated, CW in this example, it encounters resistance from the corner 41 of spring loaded plate 36. Further turning of the skewer spreads parts 35 and 36 apart from each other against the constantly applied spring force from 38 exerted upon plate 36 until, after a full 90 degree turn, the over-the-center action of the leading edge of skewer blade 32 causes it to snap into locked position within the confines of the new rectangular aperture 42, formed between parts 35 and 36, shown at FIG. 4D. This requires only minimal manual force, yet results in clamping the skewer blade firmly against the vertical surfaces of fixture 31.

Subsequently, the skewer is quickly and effortlessly released with a ¼ turn in the opposite direction.

Height Adjustment

Commercially available skewers range in length from approximately 5 inches for round wooden types up to 20″ for some made of stainless steel. Although it may be impractical, and even unnecessary, to design a serving column capable of accommodating such an entire wide range of lengths, a more practical solution would be to designate a modicum of several length groups to be handled by several model sizes, such as from 5″ to 10″, from 10″ to 16″, from 12″ to 18″, and from 14″ to 20″, for example.

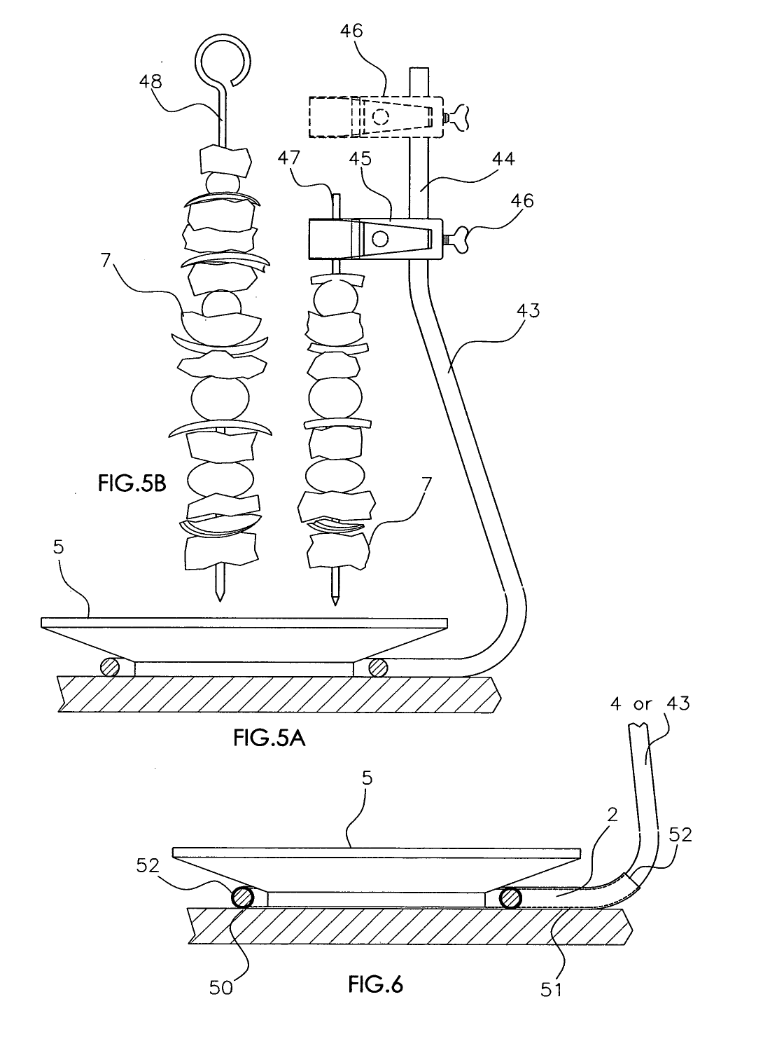

FIG. 5A shows a design variation of support column 4, replaced by column 43, having a vertical extension 44, on which the skewer supporting fixture 45 is mounted in a vertically adjustable fashion, secured at any desired height by lock screw 46, and holding a short loaded skewer 47. In this sample view, the fixture 45 resembles fixture 14 of FIG. 3A, but may be substituted by either fixture 10, 31 or others not shown herein.

Fixture 45 is also indicated in dotted lines near its topmost position, along with a longer loaded skewer 48, to highlight the height adjustment benefit.

Table Protection

To protect delicate surfaces of whatever is used as a dining table against marring and scratching, the entire bottom surfaces 50 of base 2 and those portions 51 of column 4 coming in contact with the table surface 3 are covered with a protective coating 52 of soft material, providing a cushion against rough handling as well as friction to reduce sliding on slippery surfaces. This is provided in the form of a tubular or semi tubular jacket of suitable material, or in the form of a semi liquid dip coating, allowed to cure to an integral rubber like consistency, applied to the bottom portion of device 1, as shown in FIG. 6.

Stand Alone Support Column

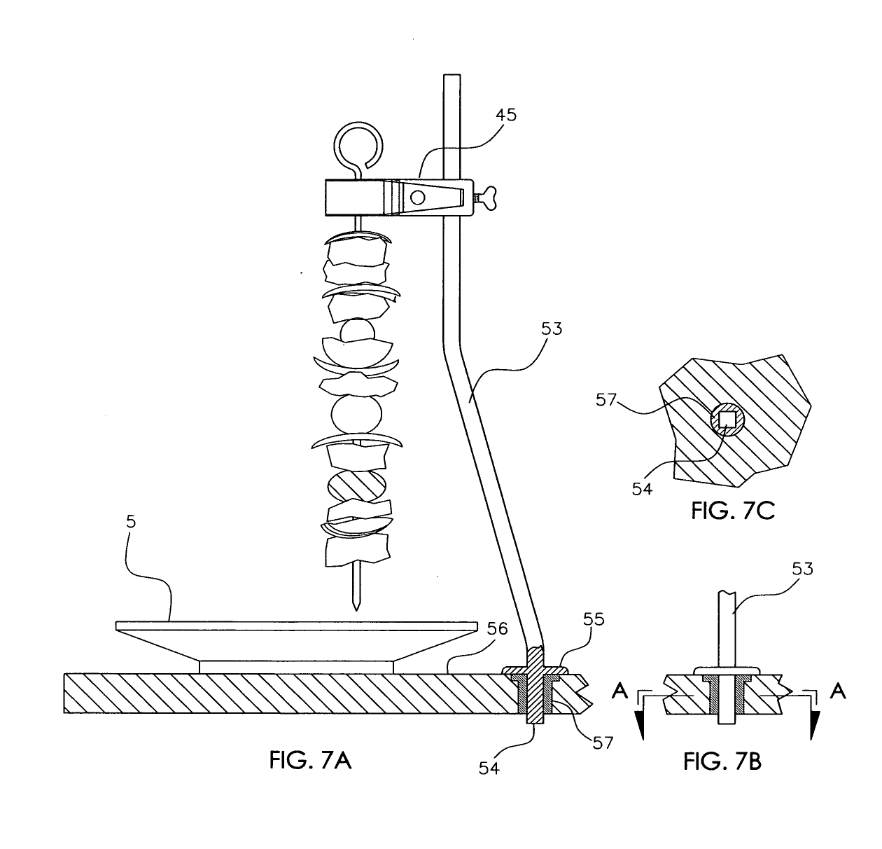

The previously illustrated exemplars of this invention have all cited the use of a ring shaped base 2, to be placed on the table area which is designated for each person's dinner plate, and to which the support column or columns 4 or 43 are directly attached. The advantage of this method is that a culinary gathering featuring this method of serving kabob food can be staged almost anywhere, whether in a private home, or at any restaurant or other public venue, by simply setting the dining tables to include one of the aforementioned kabob serving devices 1 for each participant. No other preparation is necessary, and upon completion, all implements are removed for cleaning and storage, leaving the dining table undisturbed for other functions.

Where such events are repeatedly staged with any kind of frequency, and where the number of participants is greater than would be considered an intimate group, another embodiment of this invention can provide several important advantages. Instead of utilizing a support column 4 with an integral horizontal base 2, the support column incorporates at its lower extremity an anchor type mounting provision, such as one or more pins fit into a matching anchor hole permanently built into the dining table. Such an embodiment is shown in FIG. 7A, where support column 53 terminates at the bottom with a vertically oriented square protrusion 54 and a flange 55. Table surface 56, at one or more strategic locations, incorporates an anchor bushing 57, permanently affixed to the table, which includes a through hole 58 of identical shape as protrusion 54, precision sized to provide a close sliding fit, so that once column 53 is installed by inserting 54 into hole 58, column 53 is in a substantially rigid and secure position, unable to sway or rotate, and poised precisely behind the spot designated for each guests dinner plate 5. If deemed necessary, a threaded fastener (not shown) may be added to prevent accidental disturbances, accessible from either top or bottom of the table.

The skewer receptacle 45 at the top of support column 53 can be either of the several types described previously from FIG. 2 through FIG. 5.

The major advantages of this arrangement are:

Stand alone columns are less expensive to produce, require less storage space, and are easier to clean as well as to transport. Tables for large groups can be prepared much more quickly, and placement of the support columns is always precise and repeatable due to the built-in anchor holes. Decorative plugs (not shown) can be utilized to hide the anchor holes when not in use.

Artistic Components

Almost all kinds of objects, containers, serving tools, implements or utensils used in the endeavor of displaying, dispensing, serving and consuming any kind of food, from simple sandwich meals to sophisticated fine dining extravaganzas, have always been concomitant with equally and often overwhelmingly creative displays of artistic accompaniments, expressed in a multitude of amazing forms. There are innumerable artful designs for any kind of silverware, ornamental shapes with colorful renderings in chinaware, eye appealing choices in dining furniture and an unending array of table decor, to mention only a fraction of what comes to mind. All of these artistic contributions are in addition to the already inherent practical attributes of these articles, and for centuries they have served only one purpose: To add visual pleasure to the pleasure of dining, thus enhancing and maximizing each culinary experience, especially when sharing it in the company of others.

Inasmuch as this invention constitutes an entirely new and novel form of serving kabob type food, the mere and unfamiliar appearance of skewer support columns on the dining table already adds an unexpected element of visual delight to the milieu. It is almost a natural urge to add some artistic flourish to these new elements, in order to further enhance them and regard them as a new and welcome type of table decoration.

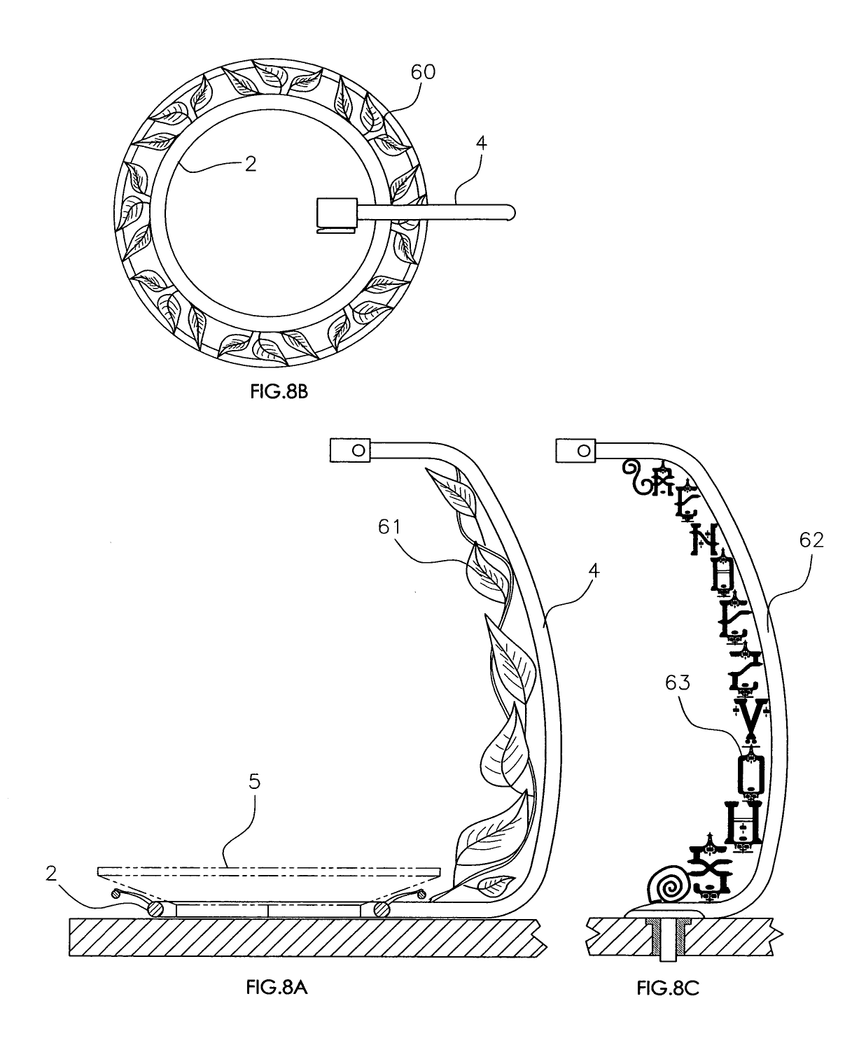

FIGS. 8A and 8B gives an example of how this can be accomplished, by adding decorative elements 60 to a modified base 2, and elements 61 to a modified support column 4. Clearly the shape, material, design and almost any aspect of this concept will lead to an endless list of alternate results.

FIG. 8C shows this principle being applied as well to the table mounted column version, and simultaneously addresses the opportunity to also utilize this invention for promotional displays 63, such as business names, logos, slogans etc. as would be useful to any number of commercial enterprises. As is the case with the artistic aspect, the commercially available opportunities that this invention facilitates are simply limitless.

Incorporation of Condiment Receptacles

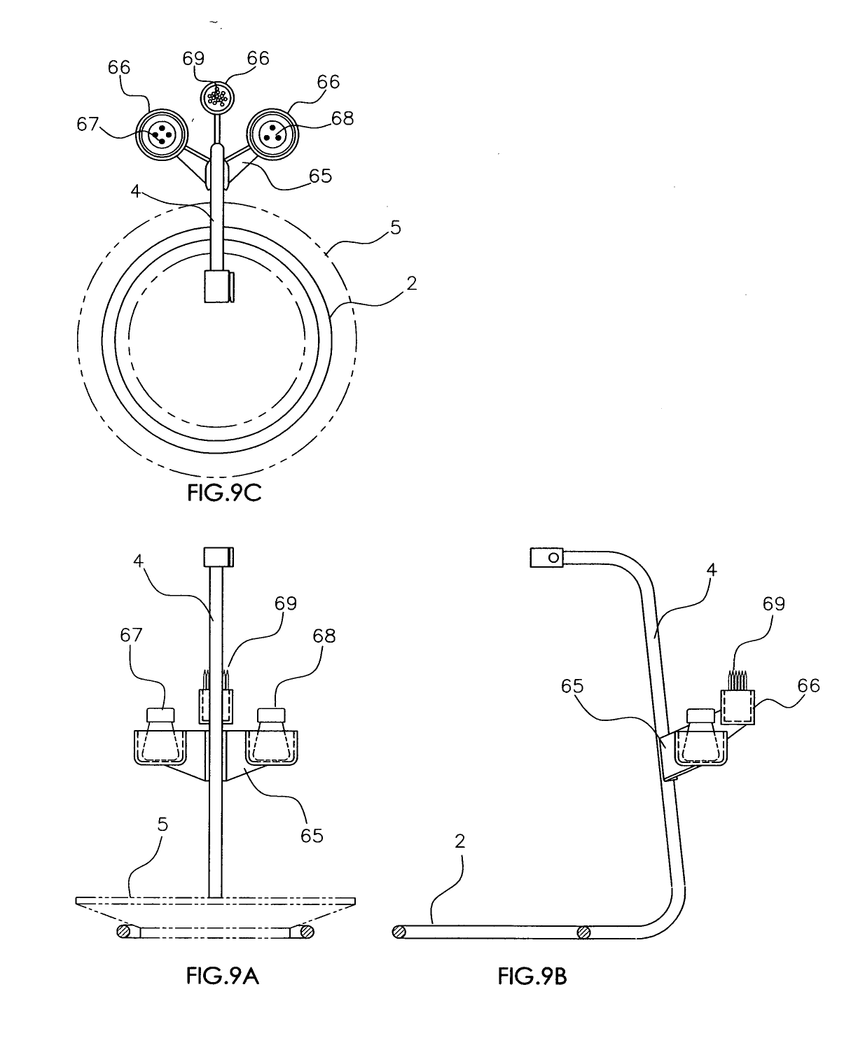

FIG. 9A, in a front view of one of the previously described examples, shows the addition of a bracket 65, removably attached to support column 4. The bracket can be made from any suitable material, and so designed as to be snapped on to selected parts of the support column 4, preferably without the use of any tools.

Bracket 65 supports one or a multiplicity of cup like cavities 66, which are appropriately sized to carry such necessities as salt and pepper shaker 67 and 68, tooth picks 69 or any other type of spice or condiment deemed desirable.

FIG. 9B is the side view, and FIG. 9C the top view of this sample configuration.

Signage Elements

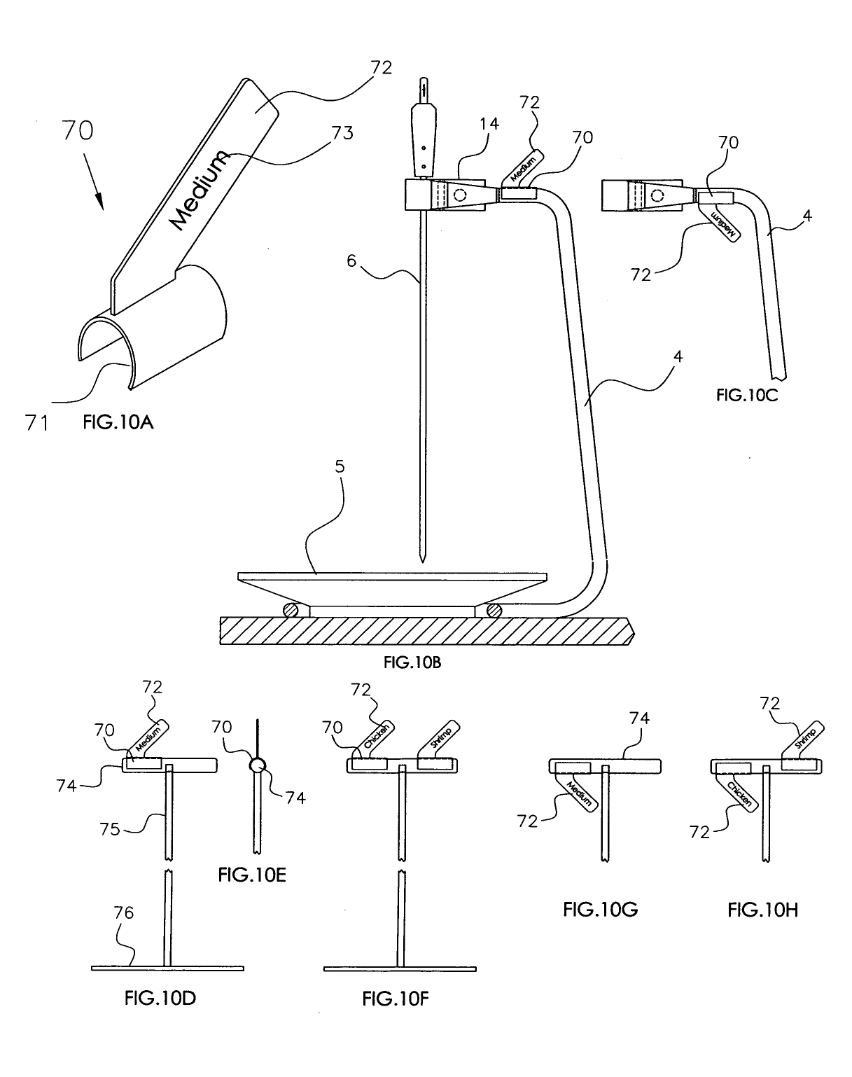

FIG. 10A is an isometric view of a snap-on sign 70, consisting of a mounting portion 71 and a flag portion 72. It is made of a semi rigid material having flexible properties, allowing it to be easily snapped in and out of place within certain areas of support column 4 of skewer support fixture 1. The flag portion 72 bears an inscription 73 on both of its sides, which displays in brief terms the information a diner at a kabob dinner would give to the grill cook in order to convey his or her selection of available food choices, and if applicable, include their preferred degree of preparation.

Examples of the signage would include, but not be limited to: Rare, Medium-rare, Medium, Medium-well, Well-done, etc., all of which would be useful in the preparation of beef kabob. Where many varieties of foods are being offered, the sign legend may further include such callouts as: Beef, Lamb, Pork, Chicken, Shrimp, Corn, Peppers, and whatever else is appropriate.

The recognition effect of this signage may be enhanced by making the various signs 70 in different colors, using single or multiple combinations of colors for maximum effectiveness. This will become more clearly understood and appreciated when the companion element 78 is introduced in the succeeding paragraph “Skewer Signage”.

At the beginning of each culinary gathering, and prior to preparing the food, each participant selects one or more of these snap-on signs 70 from bins or racks containing a suitable quantity of all those that reflect the choices available at this event. For instance, if only beef is served, signs with the legend “Rare”, “Medium”, “Well done” etc. would be supplied. If chicken and shrimps are also being served, those signs would also be present, but never any that do not apply to the menu in force. Once seated, the diner will affix the selected sign, which reflects their exact preferences, to his or her individual skewer support column 4 at a designated location thereon. If more than one choice is selected, two can be displayed on a dual column fixture (FIG. 1D), otherwise they are displayed singly, one serving at a time.

FIG. 10B illustrates the snap-on sign 70 in position on support column 4, with flag 72 facing upward. While held firmly in this position due to a snug friction fit, the sign can however be easily manipulated to face in the opposite direction, as shown in FIG. 10C. This capability is now exploited to express another meaningful input, instantly conveyed to the grill cook, namely: The “UP” position shall mean: This skewer column is “READY” for a loaded skewer! And of course the sign itself specifies what that skewer must contain.

It follows that by orienting the flag 72 in the opposite direction, as shown in FIG. 10C, that indicates to the grill cook, at least for the moment, that this diner does not require anything. As can be deduced just from this paragraph, this silent form of sign communication almost preempts the need for verbal negotiations, does not rely on memory, avoids misunderstandings, and makes it unnecessary for the grill cook to associate persons, names or faces with any specific order. This is of particular benefit the larger the group of people in the party becomes, and the more grill cooks are serving the group.

Using the snap-on signs 70 for the purposes described herein would undoubtedly become the convention or norm for such events, as it is easily understood and followed by everyone. And it is left open to any group to expand these conventions in order to suit their own attributes or peculiarities.

Signage Elements Used for Other than Kabob Dinners

The subsequent paragraph “Skewer Signage” ties the foregoing signage 73 to a second element 81, and together this results in a most efficient method for serving and controlling kabob dinners. However, the signage system of the previous paragraph is not only valuable for tagging the kabob serving columns 4 and 43, and 53, but is also very useful and efficient for any other kind of barbecue event not using kabob skewers. It can be used for serving steak, hamburgers, ribs, whole chicken, fish or vegetables, just to give an example. That means, because for these events there is no need for a kabob serving device having a serving column 4 for the signage element 70 to be attached to, there needs to be another element on the table for that purpose.

That is accomplished by sign carrier 74, shown in FIG. 10D. Each sign carrier 74, is sitting on the table in lieu of a kabob serving device, one for each dinner participant, representing their individual place setting at the table. The sign carrier's arbor 74 is held high above the table by leg 75, supported by bottom flange 76. Each sign carrier 74 can actually hold two snap-on signs 70, as shown in FIG. 10F, allowing more than one menu choice to be selected at a time.

VIEW 10E is an end view of sign carrier 74, and FIGS. 10F, 10G and 10H show examples of several ways the sign elements 70 can be oriented on the sign carrier to indicate the preferred menu choices of each participant.

Skewer Signage

Having thus improved the method of communicating the exact requirements of each diner to those doing the cooking, the same principle of using explicit signage is now applied in order to facilitate fulfilling those requirements.

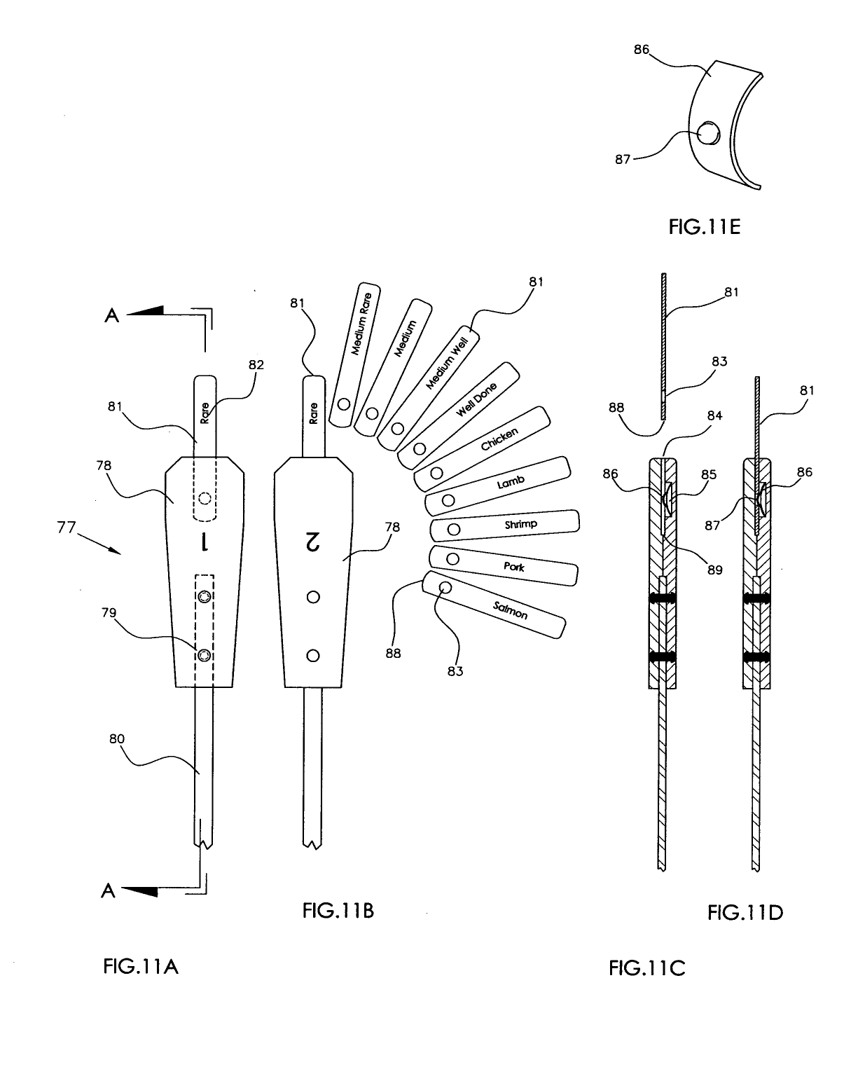

FIG. 11A is a partial view of a skewer 77, showing one side of handle 78, fastened by rivets 79 to blade 80. At the upper extremity of handle 78 a tab 81 is protruding from it, bearing an inscription 82, in this case the word “Rare”. FIG. 11B shows the opposite side of handle 78, as well as the opposite side of tab 91, bearing the identical inscription 82. Next to this is shown an array of identically shaped tabs 81, each bearing a different inscription. Tabs 81 are made from a thin semi-rigid material having good wear resistance, heat resistance, and imprint retention, somewhat like that of a typical credit card. At the opposite extremity each tab incorporates a hole 83.

FIG. 11C is a sectional view of the handle 78, taken along the line A-A of FIG. 11A. At its upper extremity handle 78 incorporates a cavity 84, an internal pocket 85, and a curved flat spring 86 having a dome shaped dimple 87, as shown in the enlarged detail of FIG. 11E. The sectional view at FIG. 11C shows the relaxed spring 86 resting within pocket 85, with its domed dimple 87 protruding into the vacant cavity 84. One such tab 81 is shown above the handle 78 to indicate its imminent entry into cavity 84, hole end 88 first.

FIG. 11D is the same sectional view of handle 78, but shows it now with tab 81 fully inserted. During insertion, as the leading edge 88 of tab 81 makes contact with dimple 87 of spring 86, it depresses and deflects spring 86 until it reaches its full insertion depth at the bottom of cavity 84. At that point, hole 83 is aligned with dimple 87, which can now spring back with a “indent” effect, filling hole 83. This effectively locks tab 81 gently but firmly to skewer handle 78, preventing it from falling away during any subsequent handling of the skewer. Yet it requires only a minimal pulling force to extract tab 81 once it becomes necessary to replace it with another.

The tabs 81 will bear exactly the same inscription as the flags 72 of the column mounted snap-on signs 70 which were described previously and shown in FIG. 10A. If a system of color coding those snap-on signs 70 has been adopted, that same system must be employed for tabs 81, thus making it possible to facilitate an instant visual color match of the two elements.

Given a supply of tabs 81, representing every applicable menu choice, together with a sufficient number of empty skewers, It is now possible to use the sum of all the upwardly oriented flags 72 of the snap-on signs 70 that are displayed on all the columns 4, 43, 53, or 63 to assemble the exact number of skewers needed with the exact callout of what they must contain, by simply inserting one tab 81 for each like flag 72 into the handle of a blank skewer. Those persons responsible for loading the skewers with the proper types of food can now simply follow what is indicated on each protruding tab 81. The resulting array of loaded skewers so marked can then be grouped on the grill in sensible categories, which in turn aids in producing the proper processing results, even if more than one person is handling the cooking process.

A still further benefit is derived by marking the handle 78 of each individual skewer 77 with the numeral “1” on one side and “2” on the other, as shown in FIGS. 11A and 11B. These markings can be permanent, as they bear no relationship to the legends Imprinted on tabs 81. This will be another welcome aid to any grill cook, by making it easier to overview and control timely turning of the skewers, basting where and when needed, and thus circumventing over- or undercooking.

And as can be deduced from these scenarios, the signage system of this invention is of particular value when it comes time to distribute the “done” skewers to the correct recipients. No longer is it necessary to remember who asked for what, but each tagged skewer is simply delivered to a kabob support column that bears the color and callout matching the tab on each skewer.

Skewer Signage Serves Any Kabob Type Dining

Even if a kabob dinner is conducted without benefit of the kabob serving column fixture 1 shown in FIGS. 1 and 7, the skewer signage described in the previous paragraph is still of great advantage to all participants when used independently from the signage elements 70 of FIG. 10A. Having each skewer labeled before, during and after grilling will greatly aid in the planning, preparation and serving process.

Adapter for Outdoor Use

All of the various forms of kabob serving devices described heretofore are ideally suited for any kind of outdoor dining, be it at a backyard family barbecue, a picnic on the beach, in a park, campground or nature setting, or at a road trip stop near some creek or other scenic spot.

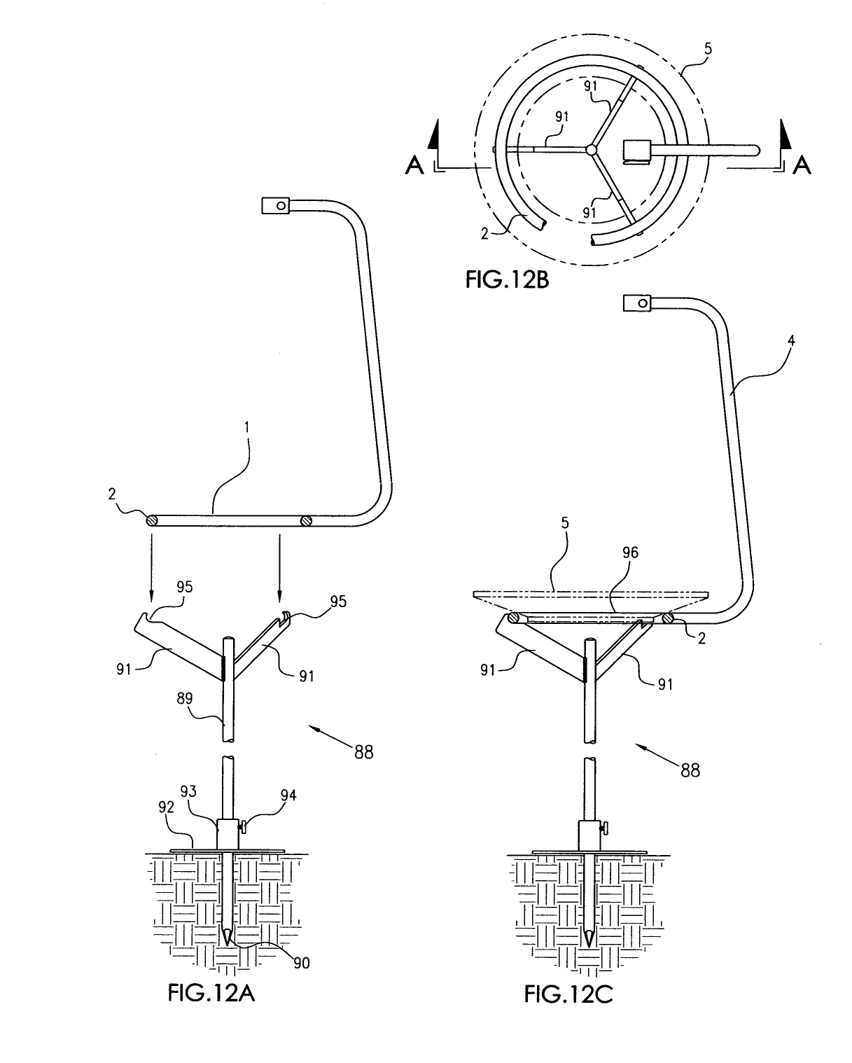

FIG. 12A shows an adapter 88, which facilitates the use of any of the previously described kabob serving devices for just such occasions. It consists of a central leg 89 having a sharp point 90 at its lower extremity, a multiplicity of brackets 91 attached thereto, a flange 92 with integral hub 93 and locking screw 94.

With flange 92 initially raised to a high position, the pointed end 90 is driven into the ground to any desired depth, whereupon the flange 92 is lowered to touch the ground, and secured there by locking screw 94. This provides an additional degree of stability and guards against accidental tilting.

The upper portion of FIG. 12A shows the kabob serving device 1 is then being placed upon the brackets 91, of which their extremities 95 are shaped to engage perfectly with base 2 of device 1. Referring to FIG. 12C which is a sectional view taken along line A-A of top view FIG. 12B, the resulting assembly now provides a platform 96, on which a dinner plate 5 is placed, seating on the top surface of base ring 2, and held in concentric position by the conical shape of the plate 5 itself. As will be clear from this description, the final height of plate 5 is determined by the length of central leg 89, and the depth to which it is driven into the ground. At the election of the user, that height can be set at a low level just out of reach of ants, or as high as a normal table, depending on the users comfort.

Special Skewer (Optional)

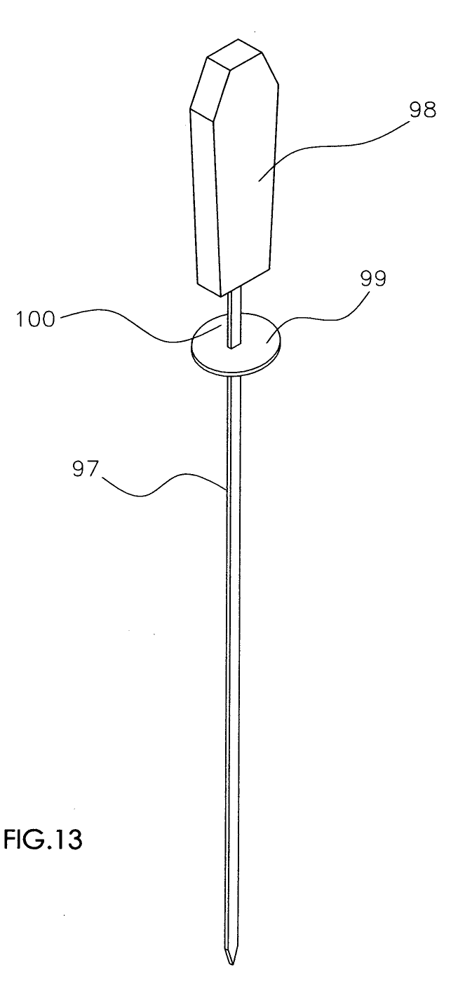

To facilitate the preparation and grilling of kabob food, the skewers used with this invention may be modified as shown in FIG. 13, where 97 is the skewer blade, 98 is a handle of any desired shape and size, and 99 is a thin washer of circular, square or rectangular shape. The washer 99 is firmly affixed to blade 97 near handle 98, leaving a space 100 between handle 98 and washer 99 which is slightly in excess of the maximum vertical height of any of the previously described skewer clamping devices 10, 14, 31, and 45. This assures that the uppermost skewer area needed for supporting and clamping the skewer is always left vacant for that purpose.

I claim:

1. A method and device for serving one or more single or multiple pronged kabob skewers holding chunks of kabob food impaled thereon, comprising:
a. a horizontally disposed base element to be placed upon a table,
b. an integral vertically disposed columnar element,
c. fastening means attached to said columnar element for temporarily and removably affixing said kabob skewer(s) vertically above said base element,
said base element forming a circular or polygon shaped rim, sized to accommodate a dinner plate or other vessel of well known dimensions within its confines, so as to position said skewer(s) at a suitable height above a predetermined area of said vessel for the purpose of effortlessly removing said food chunks from said skewer(s) directly onto said plate or vessel without the need to hold said skewer(s) by hand;

2. the serving device of claim 1 including cushioning means encasing the base element resting on a table surface, to protect said surface against scratching or marring resulting from normal handling of said serving device, said cushioning means being comprised of a layer of soft resilient material applied to the surfaces of said base element;

3. a method and device for serving one or more single or multiple pronged kabob skewers holding chunks of kabob food impaled thereon, comprising:
a. a vertically disposed columnar element, secured to a table surface at a designated location,
b. anchoring means built into said table surface, to rigidly yet removably hold said columnar element locked in said location,
c. fastening means attached to said columnar element for temporarily and removably affixing said kabob skewer(s) vertically above said designated location intended to accommodate a dinner plate or other vessel of well known dimensions,
so as to position said skewer(s) at a suitable height above a predetermined area of said vessel for the purpose of effortlessly removing said food chunks from said skewer(s) directly onto said plate or vessel without the need to hold said skewer(s) by hand;

4. the serving device of claim 1 including means for supporting a single prong skewer by engaging the topmost portion of its blade and a portion of its handle within a correspondingly shaped receptacle, which by the mere force of gravity imparts restraints upon said skewer, rendering it incapable of significant lateral or rotary movement in either direction, thus causing the entire length of said skewer blade to remain essentially stable for the purpose of removing food impaled thereon;

5. the serving device of claim 1 including means for supporting single and multiple prong skewers having a blade cross section of rectangular, square or round profile, and any given shape and size of handle, including the absence of an actual handle, by engaging the uppermost accessible portion of said blade, using clamping pressure induced by spring force or mechanical locking screw, so as to grip said skewer blade tightly and rendering it incapable of lateral or rotary movement in any direction, thus causing the entire length of said blade to remain stable for the purpose of removing food impaled thereon;

6. the serving device of claim 1 including means for supporting a single prong skewer having a blade of rectangular profile cross section, and any given shape and size of handle, by clamping the uppermost portion of said blade just below said handle with a spring loaded mechanism requiring merely a quarter turn engagement of said blade to effect said engagement, thus causing the entire length of said skewer to remain stable for the purpose of removing food impaled thereon;

7. the serving device of claim 1 wherein said columnar element permits said skewer supporting means to be affixed to it at any selectable height within a predetermined range, so as to permit skewers having different lengths within that range to be used on the same said serving device;

8. the serving device of claim 1 including a removably attached bracket incorporating one or more receptacles intended to carry condiments and other conveniences commonly used at dining tables;

9. the serving device of claim 3 including means for supporting a single prong skewer by engaging the topmost portion of its blade and a portion of its handle within a correspondingly shaped receptacle, which by the mere force of gravity imparts restraints upon said skewer, rendering it incapable of significant lateral or rotary movement in either direction, thus causing the entire length of said skewer blade to remain essentially stable for the purpose of removing food impaled thereon;

10. the serving device of claim 3 including means for supporting single and multiple prong skewers having a blade cross section of rectangular, square or round profile, and any given shape and size of handle, including the absence of an actual handle, by engaging the uppermost accessible portion of said blade, using clamping pressure induced by spring force or mechanical locking screw, so as to grip said skewer blade tightly and rendering it incapable of lateral or rotary movement in any direction, thus causing the entire length of said blade to remain stable for the purpose of removing food impaled thereon;

11. the serving device of claim 3 including means for supporting a single prong skewer having a blade of rectangular profile cross section, and any given shape and size of handle, by clamping the uppermost portion of said blade just below said handle with a spring loaded mechanism requiring merely a quarter turn engagement of said blade to effect said engagement, thus causing the entire length of said skewer to remain stable for the purpose of removing food impaled thereon;

12. the serving device of claim 3 wherein said columnar element permits said skewer supporting means to be affixed to it at any selectable height within a predetermined range, so as to permit skewers having different lengths within that range to be used on the same said serving device;

13. the serving device of claim 3 including a removably attached bracket incorporating one or more receptacles intended to carry condiments and other conveniences commonly used at dining tables;

14. the serving device of claim 1 wherein said base element and said columnar element are both constructed of or are bearing artistically inspired decorative elements complementary to one another in order to provide extra table decor;

15. the serving device of claim 1 wherein said base element and said columnar element are both constructed of or are bearing commercially inspired paraphernalia to be displayed for promotional purposes;

16. the serving device of claim 3 wherein said columnar element is constructed of or bears artistically inspired decorative elements in order to provide extra table decor;

17. the serving device of claim 3 wherein said columnar element is constructed of or bears commercially inspired paraphernalia to be displayed for promotional purposes;

18. a method and means to wordlessly communicate certain menu choices of a diner at a given dining event, comprising:
a. a signage element having a mounting portion permitting quick temporary attachment to a suitable holding fixture, and a two-sided flag portion bearing the same inscription on both of its sides, said inscription phrased to express said diners choice of available food menu items at said dining event including, if applicable, said diners preferred degree of preparing said menu item,
b. a holding fixture representing a diners specific and individual table position, for holding said signage element in place in a prescribed manner;

19. the signage element of claim 18 wherein, in addition to bearing a worded descriptive legend on both sides of said flag portion, all or a portion of said signage element is also provided with a color code element, consisting of a conspicuous display of one or more colors, wherein each said color or color combination is to be associated with one of said worded descriptive legends;

20. the signage element of claim 18 wherein said mounting portion permits said signage element to be attached to said holding fixture in said prescribed manner, which consists of orienting said flag portion of said element to face in a certain direction, said direction intended to mean, for example, that the occupant at said table position is ready to receive the food menu item described on said flag portion of said signage element, and as the colloquial counterpart, orienting said flag portion in the opposite direction on said holding fixture is intended to mean that said occupant at said table position is not ready;

21. the communication method and means of claim 18, wherein said holding fixture for holding said signage element is comprised of said columnar element of claim 1 or claim 3;

22. a method and means for tagging a kabob skewer with an interchangeable sign element comprising:
a. a skewer blade of any given length and cross section,
b. a handle attached to said skewer blade incorporating a recessed slot opposite from said blade, and also incorporating detent means,
c. a multitude of two sided shields, each bearing an identical inscription on both sides, wherein each said inscription is phrased to describe one of a multiplicity of food menu items that are available at a given dining event, and if applicable, denotes certain preferred degrees of preparation of said menu items, with each of said shields incorporating at their insertion end means for mechanical engagement coinciding with the full depth of insertion into said recessed slot of said handle,
whereby any one of said shields, when temporarily inserted into said recessed slot on said skewer handle, upon reaching said full depth of insertion, is held in that position by said detent means engaging said shield at said point of mechanical engagement;

23. the kabob tagging means of claim 22, wherein, in addition to bearing a worded descriptive legend on both sides of said shield, all or a portion of said shield is also provided with a color code element, consisting of a conspicuous display of one or more colors, wherein each said color or color combination is to be associated with one of said worded inscriptions;

24. the kabob tagging method and means of claim 22, wherein said methodology and conventions, comprised of the definition of each said descriptive worded legend and its associated color coding, are congruent with the methodology and conventions cited for said signage element of claim 18;

25. the kabob skewer of claim 22, incorporating clearly understood markings provided to distinguish one side of said handle from the opposite side, wherein one side of said handle bears the numeral 1 (one) affixed to it in a permanent manner, with the opposite side bearing the numeral 2 (two) in the same manner, or alternately the letters A and B or any other two symbols able to make differentiation of the two skewer sides obvious to anyone, including those using a mother tongue other than English;

26. the kabob skewer of claim 22, including a thin planar element of circular, oblong or polygon shape, immovably affixed at an aperture through its center to said skewer blade at a predetermined distance away from said handle end, said distance defining a dimension slightly in excess of the widest height dimension found on any of said skewer supporting means cited in claims 1 through 6, so as to prevent the portion of said skewer blade located within said predetermined distance from becoming loaded with food;

27. the kabob serving device of claim 1, including a mounting bracket for adapting said kabob serving device for outdoor usage in the absence of a table or similar surface, said bracket being comprised of a bottom portion including a ground piercing support leg, a height adjustable stabilizing flange, and an upper portion comprised of adaptive means to fit said base element of said serving device.
